(19) United States
(12) Patent Application Publication
(10) Pub. No.: US 2025/0330876 A1
(43) Pub. Date: Oct. 23, 2025

(54) 5GS USER PLANE HANDLING ENHANCEMENT FOR XR SERVICE

(71) Applicant: Lenovo (Beijing) Limited, Beijing (CN)

(72) Inventors: Haiyan Luo, Shanghai (CN); Tingfang Tang, Beijing (CN); Mingzeng Dai, Shanghai (CN); Genadi Vasilev Velev, Darmstadt (DE)

(73) Assignee: Lenovo (Beijing) Limited, Beijing (CN)

(21) Appl. No.: 18/851,279

(22) PCT Filed: Mar. 29, 2022
(86) PCT No.: PCT/CN2022/083715

§ 371 Date: Sep. 26, 2024

(51) Int. Cl. H04W 28/10; H04L 47/32; H04W 28/02

(52) U.S. Cl. CPC H04W 28/10; H04L 47/323; H04W 28/0268

(57) ABSTRACT

Method and apparatus for processing Extended Reality (XR) traffic are disclosed. In one embodiment, session management function (SMF) comprises a processor and a transceiver coupled to the processor, wherein the processor is configured to construct, for specific user equipment (UE) or Protocol Data Unit (PDU) session, stream information and PDU set integrated packet handling information, wherein, the stream information includes at least one stream indicator each indicating a stream associated with XR traffic, and the PDU set integrated packet handling information includes indication for PDU set integrated packet handling associated with each stream indicator; and transmit, via the transceiver, the constructed stream information and PDU set integrated packet handling information to User Plane Function (UPF) or Radio Access Network (RAN) node.

### FIELD

The subject matter disclosed herein generally relates to wireless communications, and more particularly relates to 5GS user plane handling enhancement for XR service.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Extended Reality (XR), Augmented Reality (AR), Virtual Reality (VR), Cloud Gaming (CG), Quality of Service (QOS), Field of View (FOV), Group of Picture (GoP), Intra frame (I-frame), Predictive frame (P-frame), Bi-directional frame (B-frame), XR and Media service (XRM), Protocol Data Unit (PDU), Application Function (AF), Radio Access Network (RAN), 5G System (5GS), User Plane Function (UPF), intermediate UPF (I-UPF), Session Management Function (SMF), service data flow (SDF), serial number (SN), Internet Protocol (IP), QoS Flow ID (QFI), GPRS Tunnelling Protocol User Plane (GTP-U), 5G QOS Identifier (5QI), slice/service type (SST), Single Network Slice Selection Assistance Information (S-NSSAI), service Differentiator (SD), Data Network Name (DNN), 5G core (5GC), Application Service Provider (ASP), Policy Control Function (PCF), Network Exposure Function (NEF), Packet Flow Description (PFD), Packet Flow Description Function (PFDF), Operations and Maintenance (OAM), Policy and Charging Control (PCC), Packet Detection Rule (PDR), Forwarding Action Rule (FAR), Core network (CN), Technical Specification (TS), Access and Mobility Management Function (AMF), Unified Data Repository (UDR), Data Network (DN), Information Element (IE), Session Management Function (SMF).

Extended Reality (XR), including Augmented Reality (AR) and Virtual Reality (VR), as well as Cloud Gaming (CG), are important media applications for 5G. XR or CG application may have multiple data streams with different traffic characteristics (e.g., traffic type) and QoS requirements in both DL and UL. For example, there may be FOV (Field of View) stream, omnidirectional stream, video stream and audio stream, haptic stream etc. Packets of the same video stream may have different frame types (e.g. I-frame, P-frame, B-frame).

I-frame, as an intra-coded picture, is a complete picture and can be encoded and decoded independently, like a JPG image file.

P-frame, as a predicted picture, is not a complete frame and only contains the image changes compared to the previous frame. If the reference frame is lost, the P-frame cannot be decoded and displayed.

B-frame, as a bidirectional predicted picture, contains the changes between the previous and following reference frames. With more reference frames, the compression ratio can be higher. However, the B-frame can only be decoded when the previous and following reference frames are available.

A Group of Pictures (GOP) includes a collection of successive video frames. The first frame in a GOP is an I-frame. The following frames can be P-frames or B-frame.

A PDU Set is composed of one or more PDUs carrying the payload of one unit of information generated at the application level (e.g., a frame or video slice for XRM Services), which are of same importance requirement at application layer. All PDUs in a PDU Set are needed by the application layer to use the corresponding unit of information. In some cases, the application layer can still recover parts of the information unit, when some PDUs are missing.

Considering the nature of PDU set, the PDUs of one PDU set shall be integrated handled, which is called PDU set integrated packet handling. For example, 5GS shall guarantee that all PDUs of one PDU set has been received or successfully delivered to UE unless indicated by application function (AF) that incomplete PDU set is acceptable. Meanwhile, the PDUs of one PDU set shall be successfully delivered to UE within a given time in order to perform jointly decoding. Packets of same video stream but different frame types (e.g. I-frame and P-frame) or even different positions in the GoP (Group of Picture) are of different importance, which contributes differently to user experience. Prioritizing the transmission of the more important stream is beneficial for improving the capacity. If congestion occurs, the packets of less important stream can be dropped in order to alleviate the congestion and recover from it. Considering the fact that P-frame and B-frame cannot be decoded and displayed if the reference frame (e.g. I-frame) is lost, there are dependencies between different PDU sets. If the reference PDU set is lost, then the other frames that depend on the reference PDU set can be dropped.

As mentioned above, in some cases, the application layer can still recover parts of the information unit, even if some PDUs are missing. The following examples are considered for partial recovery of PDU set.

Example 1: if one PDU set contains multiple encoding units, some encoding unit can be recovered independently. If one PDU set contains one encoding unit, then it's not able to recover part of it if some PDUs are missing.

Example 2: different applications have different treatments for incomplete PDU set, some decoder accepts incomplete PDU set, other's not.

Example 3: different UEs have different codecs or decoding capabilities, some UEs can perform partial recovery of PDU set even if some PDUs of the PDU set are missing, other UEs can't.

Therefore, the above mentioned PDU set integrated packet handling shall not always been implemented by UPF and/or RAN node (e.g. NG-RAN node). For the above examples 1 and 2, PDU set integrated packet handling mainly depends on the application type or traffic modal. Meanwhile, PDU set integrated packet handling depends on UE's decoding capability in example 3. Considering the fact that partial recovery may be acceptable by the receiver decoder, there is another use case: If the reference PDU set (e.g., I-frame) allows partial recovery for incomplete case, then the PDU set that depends on the reference PDU set may still be useful in the receiver decoder.

This disclosure targets resolving the following issues:

How could 5GS know whether partial recovery is acceptable by the application layer if not all of its PDUs have been correctly received or delivered? In other words, whether PDU set integrated packet handling should be performed?

How could 5GS know whether the PDU sets that depend on the reference PDU set are still useful if not all of PDUs of the reference PDU set are received or delivered?

How UPF knows when to deliver the PDU set, and how to determine the PDU set is lost or dropped. How does the UPF inform the packet dropping to the downstream UPF and the AN?

How UPF, RAN node (e.g., NG-RAN node) and/or UE know which type of PDU set can be dropped for congested case?

### BRIEF SUMMARY

Method and apparatus for processing XR and media traffic are disclosed.

In one embodiment, SMF comprises a processor and a transceiver coupled to the processor, wherein the processor is configured to construct, for specific UE or PDU session, stream information and PDU set integrated packet handling information, wherein, the stream information includes at least one stream indicator each indicating a stream associated with XR traffic, and the PDU set integrated packet handling information includes indication for PDU set integrated packet handling associated with each stream indicator; and transmit, via the transceiver, the constructed stream information and PDU set integrated packet handling information to UPF or RAN node.

In some embodiment, the processor is configured to construct the stream information and the associated PDU set integrated packet handling information based on pre-configuration, wherein, the stream information includes at least one of 5QI, SST or S-NSSAI, DNN, and appId.

In some embodiment, the processor is configured to construct the stream information and the associated PDU set integrated packet handling information based on PCC rules provided by PCF, wherein, the stream information includes at least one of QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

In one embodiment, the processor is configured to transmit the constructed stream information including at least one of QFI, appId, service data flow filter, frame type, and importance value, and the associated PDU set integrated packet handling information to the UPF.

In another embodiment, the processor is configured to transmit the constructed stream information including at least one of QFI, stream ID, frame type, and importance value, and the associated PDU set integrated packet handling information to the RAN node.

In another embodiment, a network node (e.g. User Plane Function (UPF), or RAN node) of a network architecture comprises: a processor and a transceiver coupled to the processor, wherein the processor is configured to receive, via the receiver, from a session management function (SMF) of the network architecture, for specific UE and PDU session, stream information and the associated PDU set integrated packet handling information, the stream information includes at least one stream indicator each indicating a stream associated with XR traffic, and the PDU set integrated packet handling information includes indication for PDU set integrated packet handling associated with each stream indicator; and handle each stream indicated by at least one stream indicator contained in the stream information according to the indication for PDU set integrated packet handling associated with the stream indicator indicating the stream.

In some embodiment, the processor is configured to provide downstream node with discard PDU set information associated with a PDU set if the PDU set is not received completely.

In some embodiment, the stream information includes at least one of 5QI, SST or S-NSSAI, DNN, appId, QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

In yet another embodiment, a method comprises constructing, from a session management function (SMF), for specific UE or PDU session, stream information and PDU set integrated packet handling information, wherein, the stream information includes at least one stream indicator each indicating a stream associated with XR traffic, and the PDU set integrated packet handling information includes indication for PDU set integrated packet handling associated with each stream indicator; and transmitting the constructed stream information and PDU set integrated packet handling information to UPF or RAN node.

In further embodiment, a method comprises receiving, for specific UE and PDU session, stream information and the associated PDU set integrated packet handling information, the stream information includes at least one stream indicator each indicating a stream associated with XR traffic, and the PDU set integrated packet handling information includes indication for PDU set integrated packet handling associated with each stream indicator; and handling each stream indicated by at least one stream indicator contained in the stream information according to the indication for PDU set integrated packet handling associated with the stream indicator indicating the stream.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first sub-embodiment of a first embodiment;

FIG. 2 illustrates a second sub-embodiment of the first embodiment;

FIG. 3 illustrates an example of a fourth embodiment;

FIG. 4 is a schematic flow chart diagram illustrating an embodiment of a method;

FIG. 5 is a schematic flow chart diagram illustrating a further embodiment of a method; and

FIG. 6 is a schematic block diagram illustrating another apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Before describing the procedures of this disclosure, a summary of the delivering of the XR traffic, which can be traffic generated by XR, CG application or other kind of media application, is described. The XR traffic is originated from application server. In this disclosure, the application server and the application function (AF) may not be distinguished. In other words, it can be said that the XR traffic is originated from AF.

The XR traffic is transmitted from AF to UPF, and transported by service data flow (SDF) or IP packet flow. Each packet is a PDU.

An established PDU session is between UPF and UE. Different QoS flows can be present in the established PDU session. Generally, the XR traffic is transported in QoS flow of the PDU session, from UPF to RAN node (e.g. NR-RAN node: gNB) and from RAN node to UE. There can be intermediate UPF(s) (I-UPF) between UPF and RAN node.

Different packets (e.g. different PDUs) of XR traffic may have different importance requirements. A stream may be defined as being associated with packets of XR traffic with a certain importance requirement. For example, I-frame stream has a higher importance requirement than P-frame stream. Accordingly, the streams with different importance requirements can be processed differently.

So, it is necessary to identify different streams (i.e. streams with different importance requirements), and associate different handlings to different streams.

This disclosure proposes different stream indicators to indicate different streams. The stream indicators can be collectively referred to as stream information. In addition, this disclosure proposes ‘user plane handling assistant information’, which is used to describe the handling assistant information. The ‘user plane handling assistant information’ may include ‘PDU set integrated packet handling information’ and optionally ‘deliver information’.

The ‘PDU set integrated packet handling information’ includes ‘indication for PDU set integrated packet handling’, and may additionally include ‘discard indication for dependency’, ‘discard timer’, ‘discard type’, etc. Incidentally, the expression “discard” can be replaced with “drop”.

The ‘indication for PDU set integrated packet handling’ is per stream indicator.

For example, if the stream information includes stream indicator #1 and stream indicator #2, the ‘PDU set integrated packet handling information’ includes ‘indication for PDU set integrated packet handling’ associated with stream indicator #1 and ‘indication for PDU set integrated packet handling’ associated with stream indicator #2. Alternatively, indication for PDU set integrated packet handling can be associated with all the XR streams. In other words, all XR streams can be identified by one stream indicator.

It is expected that the stream indicated by one indicator is processed according to ‘indication for PDU set integrated packet handling’ associated with the one stream indicator. For example, if there are two indicators of indicator #1 and indicator #2, the stream indicated by indicator #1 is processed according to ‘indication for PDU set integrated packet handling’ associated with stream indicator #1, and the stream indicated by indicator #2 is processed according to ‘indication for PDU set integrated packet handling’ associated with stream indicator #2.

‘Indication for PDU set integrated packet handling’ is used to indicate whether to discard (or drop) the incomplete PDU set, or to discard (or drop) the remaining PDUs of the incomplete PDU set. ‘Indication for PDU set integrated packet handling’ can have a value of ‘true’ or ‘false’, or a value of ‘1’ or ‘0’. For example, ‘true’ or ‘1’ may mean that PDU set integrated packet handling is necessary, i.e., partial recovery of PDU set is not possible. PDUs of PDU set shall be dropped if some PDUs are lost or not delivered successfully within a given PDU set delay budget. On the other hand, ‘false’ or ‘0’ may mean that PDU set integrated packet handling is not necessary. That is, partial recovery of PDU set is possible and there is no need to drop the PDUs of the PDU set.

Here, it is supposed that there are two different streams: stream indicator #1 indicates I-frame stream and stream indicator #2 indicates P-frame stream. So, the ‘indication for PDU set integrated packet handling’ associated with stream indicator #1 can be ‘false’ or ‘0’, i.e. PDU set integrated packet handling is not necessary for I-frame stream. On the other hand, the ‘indication for PDU set integrated packet handling’ associated with stream indicator #2 can be ‘true’ or ‘1’, i.e. PDU set integrated packet handling is necessary for P-frame stream.

If the ‘indication for PDU set integrated packet handling’ associated with one stream indicator (e.g. indicating P-frame stream) is configured as ‘true’ or ‘1’. The ‘PDU set integrated packet handling information’ may additionally include at least one of ‘discard indication for dependency’, ‘discard timer’, and ‘discard type’ associated with the one stream indicator. For example, the ‘PDU set integrated packet handling information’ may additionally include at least one of ‘discard indication for dependency’, ‘discard timer’, and ‘discard type’ associated with stream indicator #2 (which indicates P-frame stream).

On the other hand, if the ‘indication for PDU set integrated packet handling’ associated with another stream indicator (e.g. indicating I-frame stream) is configured as ‘false’ or ‘0’, i.e. PDU set integrated packet handling is not necessary for the stream (e.g. I-frame stream) indicated by the other stream, the ‘PDU set integrated packet handling information’ does not include any of ‘discard indication for dependency’, ‘discard timer’, and ‘discard type’ associated with the other stream indicator.

‘Discard indication for dependency’ is used to indicate whether the PDU sets depending on an incomplete PDU set should be discard (or dropped) or not. ‘Discard indication for dependency’ can have a value of ‘true’ or ‘false’, or a value of ‘1’ or ‘0’. For example, ‘true’ or ‘1’ may mean that the PDU sets depending on an incomplete PDU set should be discarded, while ‘false’ or ‘0’ may mean that the PDU sets depending on an incomplete PDU set should not be discarded.

‘Discard timer’ is used to determine when the PDU set shall be discarded. For example, ‘discard timer’ starts upon receiving the first PDU of the PDU set. When ‘discard timer’ expires, if a PDU set is not received successfully (e.g. at least one PDU of the PDU set is lost or not successfully received), the PDU set is discarded.

‘Discard type’ is used to indicate which kind (e.g., type of traffic, frame type or importance value) of packet can be discarded (or dropped) in congested situation.

As mentioned above, ‘discard indication for dependency’, ‘discard timer’ and ‘discard type’ associated with a stream indicator can only be included in the ‘PDU set integrated packet handling information’ if the ‘indication for PDU set integrated packet handling’ associated with the stream indicator is ‘true’ or ‘1’. However, even if the ‘indication for PDU set integrated packet handling’ associated with a stream is ‘true’ or ‘1’, the ‘PDU set integrated packet handling information’ may not include any of ‘discard indication for dependency’, ‘discard timer’ and ‘discard type’ associated with the stream indicator. For example, UPF or RAN node determines ‘discard indication for dependency’, ‘discard timer’, and/or ‘discard type’ by pre-configuration. Alternatively, RAN node performs PDU set integrated packet handling as a transmitter (e.g. when it transmits PDU sets), i.e., it determines whether PDU of the PDU set is successfully delivered to UE based on UE's feedback or based on the PDU set delay budget. However, UPF and RAN node don't perform PDU set integrated packet handling as a receiver (e.g. when it receives PDU sets).

This disclosure proposes that each PDU towards (i.e. transmitted to) UPF and/or RAN node (e.g. NG-RAN node) contains PDU set related information. The PDU set related information is used to identify 1) to which PDU set the PDU belongs; 2) the importance of the PDU set; and 3) the dependency among the PDU set.

For example, each PDU contains some or all of PDU set related information as follows:

1) PDU set SN (serial number), SN within PDU set, the PDU set end marker, the PDU numbers (or size) of PDU set. Generally, for UPF and/or RAN node to identify “to which PDU set the PDU belongs”, it is necessary to know PDU set SN, SN within PDU set, and at least one of (the PDU set end marker, and the PDU numbers of PDU set).

2) Importance. For example, importance IE can be inserted into each PDU of the PDU set, or some PDUs of the PDU set.

3) Dependency indication. Dependency indications have the value of “standalone”, “backward” and “backward and forward”. Alternatively, the dependency indications have the value of “I-frame”, “P-frame” and “B-frame”.

4) stream ID or QFI or (QFI and stream ID). It is assumed that UPF is able to identify different streams of the XR traffic by stream ID provided by the application layer. In addition, UPF is configured by SMF to identify different streams of the XR traffic by frame type or importance value provided by the application layer. So, stream ID can be replaced by frame type or importance value. UPF delivers PDUs of PDU set of one stream to RAN node in the N3 GTP-U tunnel, which is based on PDU session granularity. If a single stream of XR traffic is contained in one QoS flow, RAN node shall be able to identify the PDU set for each QoS flow, e.g. by QoS Flow ID (QFI). If multiple streams are contained in one QoS flow, RAN node shall be able to identify the PDU set by both QFI and stream ID. In view of the above, SMF shall provide RAN node with QFI or (QFI and stream ID) to enable it to identify PDU sets of each stream.

The PDU set related information can be provided from application layer as a new IE in the IP header, or extended IP header, or a new header between IP header and the content. It is assumed that UPF just forwards the IP packet with the PDU set related information. Alternatively, it is assumed that UPF shall copy the PDU set related information provided by the application server and paste the PDU set related information into a newly defined container in the extended GTP-U header, e.g., application-aware container, or PDU-set-aware container.

The examples of stream indicator can be as follows:

### (1) Specific 5QI Value for XR Traffic:

A first example of stream indicator is specific 5QI value for XR traffic. Several pre-configured 5QI values or new standardized 5QI values can be defined for XR traffic, e.g., 5QI value=11, 12, 13 are specified or pre-configured for XR traffic. PCF includes the pre-configured 5QI value (or new standardized 5QI value) together with the service data flow (SDF) filter or flow description in the PCC rules, from which SMF knows that the SDF or the IP packet flow contains XR traffic based on the pre-configured 5QI value or new standardized 5QI value. Besides, it is assumed that SMF is pre-configured with the mapping relationship between 5QI value and ‘PDU set integrated packet handling information’. For example, if 5QI value=11, 12, 13 are for XR traffic, SMF is pre-configured with ‘PDU set integrated packet handling information’ including ‘indication for PDU set integrated packet handling’ associated with 5QI=11, ‘indication for PDU set integrated packet handling’ associated with 5QI=12, and ‘indication for PDU set integrated packet handling’ associated with 5QI=13. Incidentally, the same ‘indication for PDU set integrated packet handling’ can be mapped to multiple 5QI values. For example, ‘PDU set integrated packet handling information’ may include ‘indication for PDU set integrated packet handling’ associated with 5QI=11 and 5QI=12.

### (2) Specific SST or S-NSSAI or DNN Defined for XR Traffic,

A second example of stream information is slice/service type (SST) or S-NSSAI and optionally DNN. A new network slice type supporting XR and media service, i.e., a new slice/service type (SST), is defined. For example, SST=6 is defined to represent for XR traffic. During PDU session establishment procedure, AMF provides the S-NSSAI of the PDU session, which includes the SST and service Differentiator (SD) to SMF. SMF identifies that the PDU session is for XR and media service based on the SST value or S-NSSAI. Besides, SMF may also take DNN into consideration, e.g., the combination of S-NSSAI or SST and DNN can also be used by SMF to identify XR traffic. Besides, it is assumed that SMF is pre-configured the mapping relationship between SST or S-NSSAI or (SST or S-NSSAI and DNN) and ‘PDU set integrated packet handling information’.

The mapping of SST or S-NSSAI or (SST or S-NSSAI and DNN) and ‘PDU set integrated packet handling information’ may be provided by application function (AF). Incidentally. In particular, it is possible that AF provides AF request with AF-Service-Identifier and ‘PDU set integrated packet handling information’ based on procedure defined in 4.3.6.2 of TS 23.502. Then 5GC (e.g., NEF) translates AF-Service-Identifier into target DNN and S-NSSAI. In this way, SMF obtains the mapping of SST or S-NSSAI or (S-NSSAI, DNN) and ‘PDU set integrated packet handling information’.

(3) Application Identifier (i.e. AppId) or AppId and PFD (Packet Flow Description) Identify (i.e. pfdId)

In case that UPF is configured to detect a particular application provided by an ASP, e.g., PCF provides PCC rules which contain AppId, a third example of the ‘stream indicator can be AppId or (AppId and pfdId). That is, an AppId or a combination of AppId and pfdId can be used to identify XR traffic. The AppId or (AppId and PFD) and the associated ‘PDU set integrated packet handling information’ can be provided from AF to NEF. Alternatively, the associated ‘PDU set integrated packet handling information’ can be contained in PFD. In this condition, the AppId and PFD (containing associated ‘PDU set integrated packet handling information’) are provided from AF to NEF (e.g. PFDF in NEF). SMF can obtain the mapping of AppId or (AppId and pfdId) and the associated ‘PDU set integrated packet handling information’ according to AppId or (AppId and pfdId) from NEF (e.g. PFDF in NEF).

The above examples apply to all UEs. The following examples apply to a specific UE or PDU session.

### (4) QFI, or a Combination of QFI and Stream ID (or Frame Type or Importance Value)

UPF is able to identify different streams of the XR traffic by stream ID provided by the application server. In addition, UPF is able to identify different streams of the XR traffic by frame type or importance value provided by the application server. So, stream ID can be replaced by frame type or importance value. If a single stream of XR traffic is contained in one QoS flow, RAN node shall be able to identify the PDU set for each QoS flow, e.g. by QFI. If multiple streams are contained in one QoS flow, RAN node shall be able to identify the PDU set by both QFI and stream ID.

### (5) PDU Session ID, or (PDU Session ID and QFI) or (PDU Session ID and QFI and Stream ID)

XR traffic can be identified by a combination of PDU session ID and QFI, or a combination of PDU session ID and QFI and stream ID, where F-SEID is used to identify PDU session by SMF and UPF. The mapping of PDU session ID, or (PDU session ID and QFI) or (PDU session ID and QFI and stream ID) and associated ‘PDU set integrated packet handling information’ may be provided by SMF to UPF.

### (6) Flow Description

XR traffic can be identified by Flow description. AF may provide flow description and the associated frame type or importance. The flow description provided by AF may be obtained by PCF. PCF may provide SMF with service data flow template which may contain the flow description as service data flow filter. Therefore, SMF configures UPF with packet filter set (i.e., flow description) and the associated frame type or importance. Then UPF is able to identify frame type or importance based on the packet filter set.

The ‘user plane handling assistant information’ may additionally include ‘deliver information’. The ‘deliver information’ may include ‘PDU number or fraction threshold for delivery’, ‘deliver timer’, ‘latency timer’, etc.

‘PDU number or fraction threshold for delivery’ indicates the threshold for delivering the PDUs of the specific PDU set to a downstream node (e.g., I-UPF, RAN node) or UE. It means that if a number (i.e. equal to the number threshold) of PDUs of a PDU set is received, or a fraction of the total number of the PDUs of a PDU set is received, the delivering of the PDUs of the PDU set to the downstream node or UE starts. For example, assume that one PDU set is composed of 8 PDUs, and UPF and/or RAN node may start delivery of PDUs of the one PDU set if at least 4 (i.e. number threshold) PDUs or 50% (i.e. fraction threshold) of the PDU set have been received. If the ‘PDU number threshold for delivery’ is configured as 1, the PDU, once received, is directly delivered to the downstream UPF or RAN node or UE immediately. If the ‘PDU fraction threshold for delivery’ is configured as 100%, the PDUs of one PDU set are delivered until all PDUs of one PDU set have been received.

‘Deliver timer’ is used to determine when the PDUs of the PDU set shall be delivered. The ‘deliver timer’ starts upon receiving the first PDU of the PDU set. When the ‘deliver timer’ expires, the delivering the PDUs of the PDU set starts.

‘Latency timer’ is used to determine when the delivering of the PDUs of the PDU set stops and the remaining PDUs (i.e. PDUs that have not been delivered) of the PDU set are discarded. The ‘latency timer’ starts upon delivering the first PDU of the PDU set. When the ‘latency timer’ expires, the delivering of the PDUs of the PDU set (e.g. to a downstream node or UE) stops and the remaining PDUs (i.e. PDUs that have not been delivered) of the PDU set are discarded.

In general, ‘PDU number or fraction threshold for delivery’ or ‘deliver timer’ applies for UPF. ‘Latency timer’ applies for UPF and RAN node.

The ‘deliver information’ may also be associated with stream indicator.

According to a first embodiment, SMF configures UPF and/or RAN node with ‘stream information’ and ‘user plane handling assistant information’ in control plane.

To make description simplified, it is assumed that the ‘user plane handling assistant information’ only includes ‘PDU set integrated packet handling information’.

As mentioned above, the examples of stream indicator in ‘stream information’ can be 5QI, SST or S-NSSAI, (SST or S-NSSAI and DNN), AppId, (AppId and pfdId), QFI, (QFI and stream ID), PDU session ID, (PDU session ID and QFI), (PDU session ID and QFI and stream ID), Flow description or service data flow filter or packet filter set.

The mapping of the ‘stream information’ and ‘PDU set integrated packet handling information’ may be pre-configured in SMF (e.g., through OAM configuration provided by the operator or through per node configuration from AF via NEF or via PCF), or provided by PCF based on PCC rules, or provided from AF. For example, AF provides “stream information” and ‘PDU set integrated packet handling information’ to NEF (e.g. PFDF in NEF), and NEF (e.g. PFDF in NEF) provides them to SMF. AF provides “stream information” and PDU set integrated handling information to PCF (e.g., via NEF), and PCF provides them within PCC rules to SMF.

So, SMF can construct ‘stream information’ and ‘PDU set integrated packet handling information’, where the ‘stream information’ includes at least one stream indicator each indicating a stream associated with XR traffic, and ‘PDU set integrated packet handling information’ includes ‘indication for PDU set integrated packet handling’ associated with each stream indicator included in the ‘stream information’.

According to a first sub-embodiment of the first embodiment, SMF provides ‘stream information’ and ‘PDU set integrated packet handling information’ in a modified PDU session establishment procedure.

FIG. 1 illustrates the modified PDU session establishment procedure according to the first sub-embodiment of the first embodiment.

Legacy PDU session establishment procedure is described in 4.3.2.2.1 in TS 23.502. According to the first sub-embodiment of the first embodiment, steps 1-9 and 13-21 of the legacy PDU session establishment procedure remain unchanged. Steps 10a, 10b, 11 and 12 are modified in the modified PDU session establishment procedure according to the first sub-embodiment of the first embodiment.

In steps 1-9 which are the same as steps 1-9 of legacy PDU session establishment procedure, UE triggers the PDU session establishment procedure. AMF selects SMF and informs it to establish or modify a PDU session for the UE. SMF obtains PCC rules from PCF for the PDU session, which includes SDF template. The SDF template is either an Application identifier (appId), or a list of service data flow filters.

In step 10a, SMF sends N4 Session Establishment/Modification Request with stream information #1 and ‘PDU set integrated packet handling information’ to UPF. The stream information #1 can be at least one of 5QI, SST or S-NSSAI, DNN, appId, pfdId, e.g. 5QI, SST or S-NSSAI, (SST or S-NSSAI and DNN), appId, (appId and pfdId). As mentioned above, some examples of the stream information apply to all UEs while some other examples of the stream information apply to a specific UE or PDU session. However, when SMF provides the stream information in a PDU session establishment procedure, the provided stream information is for a specific UE or PDU session. The stream information #1 is used by UPF to identify XR traffic by stream indicator(s). With stream information #1 and ‘PDU set integrated packet handling information’ (which includes ‘indication for PDU set integrated packet handling’ associated with each stream indicator contained in stream information #1), the UPF may handle each stream indicated by the stream indicators contained in stream information #1 according to the indication for PDU set integrated packet handling associated with the stream indicator indicating the stream.

Specifically, stream information #1 and ‘PDU set integrated packet handling information’ can be contained in Forwarding Action Rules (FAR) associated with Packet Detection Rules (PDR). Alternatively, SMF provides UPF with only stream information (e.g. appId) in PDR, and UPF can obtain the ‘PDU set integrated packet handling information’ associated with appId which was previously provided by SMF based on N4 PFD management procedure. In this way, SMF doesn't need to provide UPF with the ‘PDU set integrated packet handling information’ in N4 Session Establishment/Modification Request message.

Instead, AF provides SMF with mapping of appId and PFD via NEF (e.g. PFDF in NEF). Then, SMF provides UPF with the mapping of appId and PFD by N4 PFD management procedure. Thereafter, during the PDU session establishment or modification procedure, PCF may only provide SMF with only appId in PCC rules. And SMF provides UPF with only appId, while UPF can obtain the PFD associated with the appId.

In step 10b, UPF responds SMF with N4 Session Establishment/Modification Response message.

In step 11, SMF sends Namf_Communication_N1N2MessageTransfer message to AMF, which contains PDU session ID and N2 SM information for RAN node. The N2 SM information contains stream information #2 and ‘PDU set integrated packet handling information’ (which includes ‘indication for PDU set integrated packet handling’ associated with each stream indicator contained in stream information #2). For example, N2 SM information contains QFI(s), QoS Profile(s), CN Tunnel Info, and/or S-NSSAI from the Allowed NSSAI, and ‘PDU set integrated packet handling information’. For example, ‘PDU set integrated packet handling information’ can be applied to the whole PDU session, or to specific QoS flow. That is, the ‘PDU set integrated packet handling information’ is associated to specific QFI, or associated to all the QFIs, or associated to specific QFI and stream ID (or frame type, or importance value). Optionally, SMF may provide the ‘discard timer’ and ‘discard type’ for UE in N1 SM information contained in the above message. e.g., N1 SM information contains PDU Session Establishment Accept with ‘discard timer’ and ‘discard type’. The ‘discard timer’ and ‘discard type’ can be associated with PDU session ID, or associated with QFI.

In step 12, AMF sends N2 PDU Session Request message with N2 SM information to RAN node. Specifically, N2 SM information corresponds to PDU Session Resource Setup Request Transfer IE defined in TS 38.413. That is, PDU Session Resource Setup Request Transfer IE contains stream information #2 and ‘PDU set integrated packet handling information’.

After that, steps 13-21 of the legacy PDU Session Establishment Procedure are performed.

Besides, SMF may be informed of whether UPF has the capability to perform the special user plane handling in advance, e.g., upon N4 association procedure, UPF informs SMF its capability of special user plane handling. Alternatively, SMF may be pre-configured with the capability of UPF by OAM. The special user plane handling includes adding extended GTP-U header with PDU set related information, PDU set integrated packet handling, and differentiated QoS handling, etc. As long as SMF identifies that the PDU session will carry XR traffic, SMF shall select a UPF with special user plane handling capability or functionality for the PDU session.

According to a second sub-embodiment of the first embodiment, SMF provides ‘stream information’ and ‘PDU set integrated packet handling information’ in a modified PDU session modification procedure.

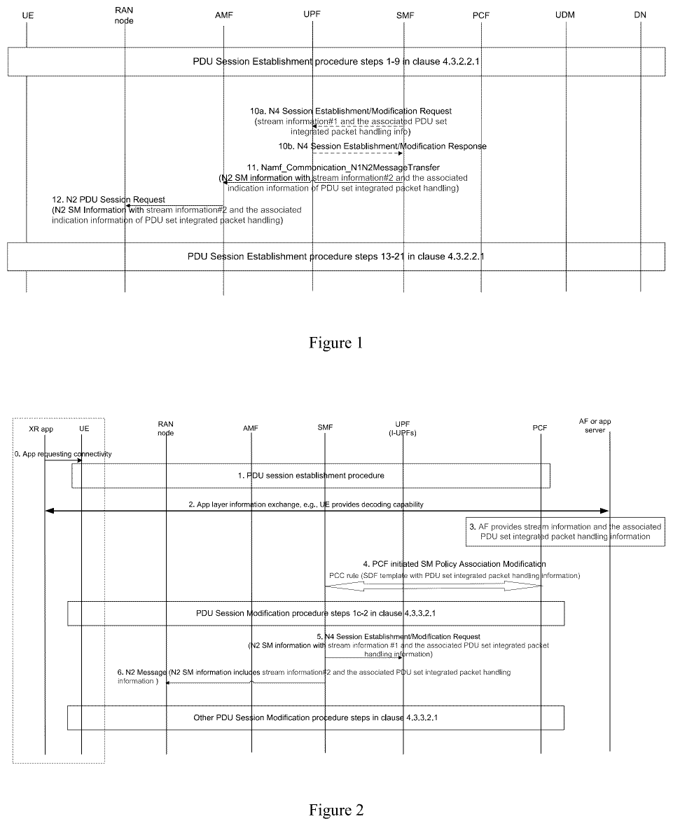

FIG. 2 illustrates the modified PDU session modification procedure according to the second sub-embodiment of the first embodiment.

Legacy PDU session modification procedure is described in 4.3.3.2 in TS 23.502. According to the second sub-embodiment of the first embodiment, steps 3, 4, 5 and 6 are modified, while other steps remain unchanged.

Step 0, the XR application in UE requests for connectivity.

Step 1, the PDU session establishment procedure is performed, by which the default QoS flow is established for the PDU session.

Step 2, the XR application in UE exchanges data with the application server over the established PDU session. UE may provide its decoding capability, e.g., it is able to perform partial recovery of PDU set. The application server shall decide whether partial recovery of a PDU set is possible at the UE based on UE's decoding capability and other information, e.g., the encoding scheme, frame type or importance, etc. The application server constructs the ‘user plane handling assistant information’ for 5GS, which includes ‘PDU set integrated packet handling information’ and/or ‘deliver information’.

Step 3, AF provides 5GC (e.g., PCF, or PCF and NEF) with stream information and the associated ‘PDU set integrated packet handling information’, where stream information, which is for a specific UE or PDU session, may include UE address, or (UE address and Flow description). That is, the ‘PDU set integrated packet handling information’ can be applied to the whole PDU session identified by UE address. Alternatively, the ‘PDU set integrated packet handling information’ can be applied to specific flow or stream of the PDU session identified by (UE address and Flow description). For example, AF triggers setting up an AF session with required QoS and the ‘PDU set integrated packet handling information’ based on 4.15.6.6 of TS 23.502. Alternatively, AF provides 5GC (e.g., PCF) with the ‘PDU set integrated packet handling information’ based on the procedure in TS 23.502 4.3.6.4 (Transferring an AF request targeting an individual UE address to the relevant PCF).

Step 4, PCF performs a PCF initiated SM Policy Associated Modification procedure in order to provide SMF with PCC rules including SDF template (e.g., service data flow filter) and the corresponding ‘PDU set integrated packet handling information’. For example, PCF provides UE ID (e.g., SUPI), PDU Session ID, service data flow filter with ‘PDU set integrated packet handling information’. Then, SMF knows the ‘PDU set integrated packet handling information’ shall be applied to the service data flow of the PDU session of the UE. Here, at least one of PDU session ID, service data flow filter can be regarded as stream information.

Step 5, SMF sends N4 Session Modification request to UPF, which contains N2 SM information with stream information #1 and ‘PDU set integrated packet handling information’. Similar description as in step 10a in FIG. 1. Stream information #1 may be at least one of packet filter set (or service data flow filter or flow description) and QFI.

Step 6, SMF sends RAN node N2 SM information which includes stream information #2 and ‘PDU set integrated packet handling information’ via AMF as step 11 and 12 in FIG. 4. The only difference between step 6 in FIG. 2 and step 12 in FIG. 1 is that the messages containing N2 SM information are different. The stream information #2 may be QFI or (QFI and stream ID), where stream ID can be replaced with frame type or importance value.

Other steps are the same as the PDU session modification procedure defined in 4.3.3.2.1 of TS 23.502.

A third sub-embodiment of the first embodiment is relating to UE handover from source gNB to target gNB.

Source gNB should provide target gNB with stream information #2 and the associated ‘PDU set integrated packet handling information’, in order for the target gNB to know whether PDU set dropping should be performed if the PDU set is incompletely received or delivered, and whether to drop the PDU set if the reference PDU set it depends on is already incomplete. For example, stream information (stream information #2) and the associated ‘PDU set integrated packet handling information’ may be contained in PDU Session Resources To Be Setup List IE of Handover Request message over Xn interface.

Besides, gNB-CU should provide the gNB-DU with stream information #2 and the associated ‘PDU set integrated packet handling information’ for similar reason. For example, stream information #2 and the associated ‘PDU set integrated packet handling information’ may be contained in DRB to Be Setup List IE of UE CONTEXT SETUP/MODIFICATION REQUEST message over F1 interface.

According to a second embodiment, application provides indication for PDU set integrated packet handling per PDU set.

According to the second embodiment, whether PDU set integrated packet handling should be performed is dynamically depends on specific PDU set. For example, an indication for PDU set integrated packet handling should be added into PDU set related information piggybacked in each PDU. For each PDU set, UPF or RAN node decides whether to drop the whole PDU set if it is incomplete based on the indication for PDU set integrated packet handling. For example, if the indication for PDU set integrated packet handling is true for PDU set #1, PDU set #1 shall be discard if incomplete. If the indication for PDU set integrated packet handling is false for PDU set #2, PDU set #2 shall not be discarded if incomplete. The parameters to determine how to discard or drop the PDU set (e.g. at least one of ‘discard indication for dependency’, ‘discard timer’ and ‘discard type’) may be pre-configured in UPF.

According to a third embodiment, control plane solution (e.g. according to the first embodiment) and user plane solution (e.g. according to the second embodiment) are combined.

For example, 1) SMF configures UPF and/or RAN node with ‘PDU set integrated packet handling information’ excluding the ‘indication for PDU set integrated packet handling’; 2) the ‘indication for PDU set integrated packet handling’ is included into PDU set related information piggybacked in each PDU. UPF first checks whether the ‘indication for PDU set integrated packet handling’ is true or false for each PDU. If it is true, UPF determines how to handle the PDU set according to ‘PDU set integrated packet handling information’ excluding the ‘indication for PDU set integrated packet handling’ (e.g. at least one of ‘discard indication for dependency’, ‘discard timer’, and ‘discard type’) provided from SMF.

According to a fourth embodiment, UPF provide downstream node (e.g. I-UPF or RAN node) with discard PDU set information in user plane.

After SMF configures UPF with the ‘PDU set integrated packet handling information’, UPF shall perform special user plane handling. If the UPF determines a PDU set is incomplete (i.e. some PDUs of the PDU set cannot be successfully received) when the UPF has delivered part of PDUs of the incomplete PDU set to a downstream node, the UPF may provide the downstream node with discard PDU set information (i.e. the incomplete PDU set is discarded, or undelivered PDUs of the incomplete PDU set will not be delivered). Upon receiving the discard PDU set information, the downstream node stops transmitting the remaining PDUs of the PDU set identified by the discard PDU set information.

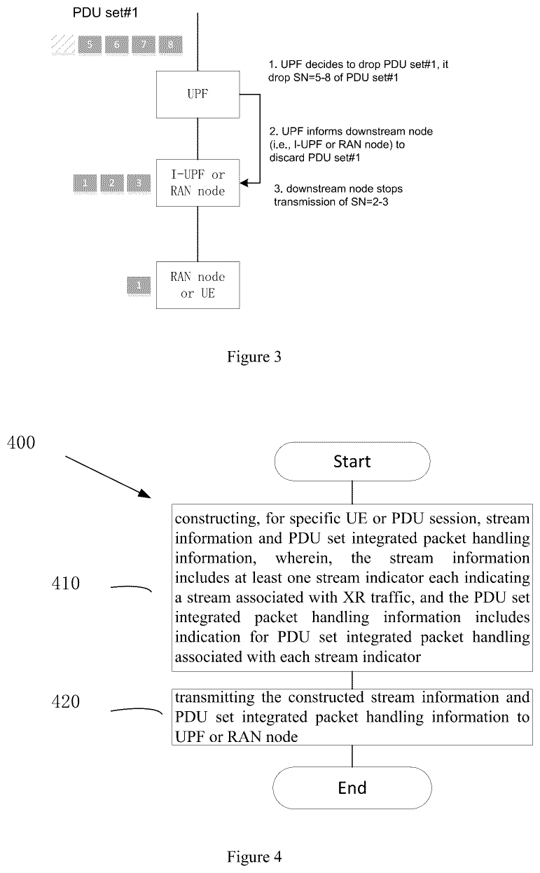

FIG. 3 illustrates an example of the fourth embodiment. PDU set #1 is composed of 8 PDUs, PDUs #1-3 have already been delivered to the downstream node, e.g. I-UPF or RAN node. In addition, RAN node has sent PDU #1 to UE. UPF determines the PDU set #1 is incomplete, e.g., PDU #4 has not been received after the ‘discard timer’ expires. UPF decides to drop the remaining PDUs of the PDU set, and it shall also inform the downstream node (I-UPF or RAN node) about ‘discard PDU set information’ (i.e. the remaining PDUs of PDU set #1 are dropped by the UPF and will not be delivered to the downstream node). When the ‘discard PDU set information’ is received by the downstream node, if the downstream node has not transmitted all the received PDUs of PDU set #1 to its further downstream node (e.g. RAN node or UE), the downstream node shall discard PDU #2 and PDU #3 which has not been sent to its further downstream node, so that the waste of radio resources for delivering PDU #2 and PDU #3 to the further downstream node can be avoided.

The discard PDU set information provided by UPF should include discard PDU set SN (e.g. PDU set #1) and stream information. Stream information can be at least one of QFI and stream ID (or frame type or importance value). For example, discard PDU set information includes QFI and discard PDU set SN for single stream in one QoS flow case, and includes QFI, stream ID and discard PDU set SN for multi-stream in one QoS flow case.

One example is to add discard PDU set information IE into DL PDU SESSION INFORMATION (PDU Type 0) of PDU session container defined in TS 38.415. Since there's already QoS Flow Identifier in the DL PDU INFORMATION (PDU Type 0) there, discard PDU set SN and stream ID (optionally) can be provided in discard PDU set information.

Another example based on the assumption that a new container (e.g., application-aware container, or PDU-set-aware container) will be defined for XR traffic, which will be inserted into the extended GTP-U header of N3/N9 interface. And the discard PDU set information IE can be added into the new container.

FIG. 4 is a schematic flow chart diagram illustrating an embodiment of a method 400 according to the present application. In some embodiments, the method 400 is performed by a network function such as an SMF or a network function with an SMF. In certain embodiments, the method 400 may be performed by a processor executing program code, for example, a microcontroller, a microprocessor, a CPU, a GPU, an auxiliary processing unit, a FPGA, or the like.

The method 400 may comprise: 410 constructing, for specific UE or PDU session, stream information and PDU set integrated packet handling information, wherein, the stream information includes at least one stream indicator each indicating a stream associated with XR traffic, and the PDU set integrated packet handling information includes indication for PDU set integrated packet handling associated with each stream indicator; and 420 transmitting the constructed stream information and PDU set integrated packet handling information to UPF or RAN node.

In some embodiment, the stream information and the associated PDU set integrated packet handling information are constructed based on pre-configuration, wherein the stream information includes at least one of 5QI, SST or S-NSSAI, DNN, and appId.

In some embodiment, the stream information and the associated PDU set integrated packet handling information are constructed based on PCC rules provided by PCF, wherein, the stream information includes at least one of QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

In one embodiment, the constructed stream information including at least one of QFI, appId, service data flow filter, frame type, and importance value, and the associated PDU set integrated packet handling information are transmitted to UPF.

In another embodiment, the constructed stream information including at least one of QFI, stream ID, frame type, and importance value, and the associated PDU set integrated packet handling information are transmitted to the RAN node.

FIG. 5 is a schematic flow chart diagram illustrating an embodiment of a method 500 according to the present application. In some embodiments, the method 500 is performed by a network node such as an UPF or a RAN node (e.g. NG-RAN node). In certain embodiments, the method 500 may be performed by a processor executing program code, for example, a microcontroller, a microprocessor, a CPU, a GPU, an auxiliary processing unit, a FPGA, or the like.

The method 500 may comprise 510 receiving, from a session management function (SMF), for specific UE and PDU session, stream information and the associated PDU set integrated packet handling information, the stream information includes at least one stream indicator each indicating a stream associated with XR traffic, and the PDU set integrated packet handling information includes indication for PDU set integrated packet handling associated with each stream indicator; and 520 handling each stream indicated by at least one stream indicator contained in the stream information according to the indication for PDU set integrated packet handling associated with the stream indicator indicating the stream.

In some embodiment, the method further comprises providing downstream node with discard PDU set information associated with a PDU set if the PDU set is not received completely.

In some embodiment, the stream information includes at least one of 5QI, SST or S-NSSAI, DNN, appId, QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

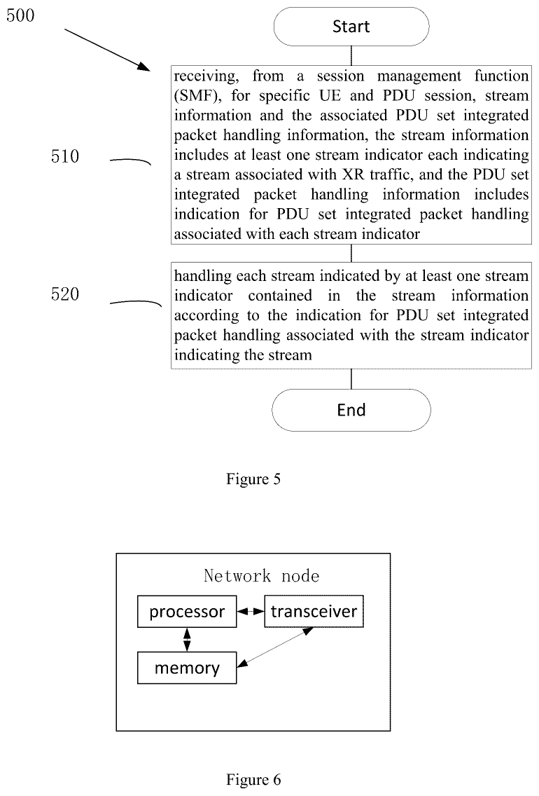

FIG. 6 is a schematic block diagram illustrating apparatuses according to one embodiment.

The network function or network node or network entity (e.g. SMF or UPF or RAN node) includes a processor, a memory, and a transceiver. The processor implements a function, a process, and/or a method which are proposed in FIG. 16 or 17.

The SMF comprises a processor and a transceiver coupled to the processor, wherein the processor is configured to construct, for specific UE or PDU session, stream information and PDU set integrated packet handling information, wherein, the stream information includes at least one stream indicator each indicating a stream associated with XR traffic, and the PDU set integrated packet handling information includes indication for PDU set integrated packet handling associated with each stream indicator; and transmit, via the transceiver, the constructed stream information and PDU set integrated packet handling information to UPF or RAN node.

In some embodiment, the processor is configured to construct the stream information and the associated PDU set integrated packet handling information based on pre-configuration, wherein, the stream information includes at least one of 5QI, SST or S-NSSAI, DNN, and appId.

In some embodiment, the processor is configured to construct the stream information and the associated PDU set integrated packet handling information based on PCC rules provided by PCF, wherein, the stream information includes at least one of QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

In one embodiment, the processor is configured to transmit the constructed stream information including at least one of QFI, appId, service data flow filter, frame type, and importance value, and the associated PDU set integrated packet handling information to the UPF.

In another embodiment, the processor is configured to transmit the constructed stream information including at least one of QFI, stream ID, frame type, and importance value, and the associated PDU set integrated packet handling information to the RAN node.

The UPF or RAN node comprises a processor and a transceiver coupled to the processor, wherein the processor is configured to receive, via the receiver, from a session management function (SMF), for specific UE and PDU session, stream information and the associated PDU set integrated packet handling information, the stream information includes at least one stream indicator each indicating a stream associated with XR traffic, and the PDU set integrated packet handling information includes indication for PDU set integrated packet handling associated with each stream indicator; and handle each stream indicated by at least one stream indicator contained in the stream information according to the indication for PDU set integrated packet handling associated with the stream indicator indicating the stream.

In some embodiment, the processor is configured to provide downstream node with discard PDU set information associated with a PDU set if the PDU set is not received completely.

In some embodiment, the stream information includes at least one of 5QI, SST or S-NSSAI, DNN, appId, QFI, stream ID, frame type, importance value, and service data flow filter.

In some embodiment, if the indication for PDU set integrated packet handling is true, the associated PDU set integrated packet handling information further includes at least one of discard indication for dependency, discard timer, and discard type.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. An apparatus for implementing a session management function (SMF), comprising:
at least one memory; and
at least one processor coupled with the at least one memory and configured to cause the apparatus to:
construct, for a specific user equipment (UE) or Protocol Data Unit (PDU) session, stream information and PDU set integrated packet handling information, wherein the stream information includes at least one stream indicator each indicating a stream associated with Extended Reality (XR) traffic, and the PDU set integrated packet handling information includes an indication for PDU set integrated packet handling associated with each stream indicator; and
transmit the constructed stream information and PDU set integrated packet handling information to a User Plane Function (UPF) or Radio Access Network (RAN) node.

2. The apparatus of claim 1, wherein the at least one processor is configured to cause the apparatus to construct the stream information and the associated PDU set integrated packet handling information based on pre-configuration, wherein the stream information includes at least one of a 5G Quality of Service Identifier (5QI), slice/service type (SST) or Single Network Slice Selection Assistance Information (S-NSSAI), a Data Network Name (DNN), or an application identifier (appId).

3. The apparatus of claim 1, wherein the at least one processor is configured to cause the apparatus to construct the stream information and the associated PDU set integrated packet handling information based on Policy and Charging Control (PCC) rules provided by a Policy Control Function (PCF), wherein the stream information includes at least one of a Quality of Service Flow ID (QFI), a stream ID, a frame type, an importance value, or a service data flow filter.

4. The apparatus of claim 1, wherein if the indication for PDU set integrated packet handling is true, the associated PDU set integrated packet handling information further includes at least one of a discard indication for dependency, a discard timer, or a discard type.

5. The apparatus of claim 1, wherein the at least one processor is configured to cause the apparatus to transmit the constructed stream information including at least one of a Quality of Service Flow ID (QFI), an application identifier (appId), a service data flow filter, a frame type, or an importance value, and the associated PDU set integrated packet handling information to the UPF.

6. The apparatus of claim 1, wherein the processor is configured to transmit the constructed stream information including at least one of a Quality of Service Flow ID (QFI), a stream ID, a frame type, or an importance value, and the associated PDU set integrated packet handling information to the RAN node.

7. A network node, comprising:
at least one memory; and
at least one processor coupled with the at least one memory and configured to cause the network node to:
receive, from a session management function (SMF), for a specific user equipment (UE) and Protocol Data Unit (PDU) session, stream information and an associated PDU set integrated packet handling information, wherein the stream information includes at least one stream indicator each indicating a stream associated with Extended Reality (XR) traffic, and the PDU set integrated packet handling information includes an indication for PDU set integrated packet handling associated with each stream indicator; and
handle each stream indicated by at least one stream indicator contained in the stream information according to the indication for PDU set integrated packet handling associated with the stream indicator indicating the stream.

8. The network node of claim 7, wherein the network node is a user plane function (UPF) or a Radio Access Network (RAN) node.

9. The network node of claim 7, wherein the at least one processor is configured to cause the network node to provide a downstream node with discard PDU set information associated with a PDU set if the PDU set is not received completely.

10. The network node of claim 7, wherein the stream information includes at least one of a 5G Quality of Service Identifier (5QI), a slice/service type (SST) or Single Network Slice Selection Assistance Information (S-NSSAI), a Data Network Name (DNN), an application identifier (appId), a QoS Flow ID (QFI), a stream ID, a frame type, an importance value, or a service data flow filter.

11. The network node of claim 7, wherein if the indication for PDU set integrated packet handling is true, the associated PDU set integrated packet handling information further includes at least one of a discard indication for dependency, a discard timer, or a discard type.

12. A method performed by a session management function (SMF), the method comprising:
constructing, for a specific user equipment (UE) or Protocol Data Unit (PDU) session, stream information and PDU set integrated packet handling information, wherein the stream information includes at least one stream indicator each indicating a stream associated with Extended Reality (XR) traffic, and the PDU set integrated packet handling information includes an indication for PDU set integrated packet handling associated with each stream indicator; and
transmitting the constructed stream information and PDU set integrated packet handling information to a User Plane Function (UPF) or Radio Access Network (RAN) node.

13. The method of claim 12, wherein the constructing comprises constructing the stream information and the associated PDU set integrated packet handling information based on pre-configuration, wherein the stream information includes at least one of a 5G Quality of Service Identifier (5QI), slice/service type (SST) or Single Network Slice Selection Assistance Information (S-NSSAI), a Data Network Name (DNN), or an application identifier (appId).

14. The method of claim 12, wherein the constructing comprises constructing the stream information and the associated PDU set integrated packet handling information based on Policy and Charging Control (PCC) rules provided by a Policy Control Function (PCF), wherein the stream information includes at least one of a Quality of Service Flow ID (QFI), a stream ID, a frame type, an importance value, or a service data flow filter.

15. The method of claim 12, wherein if the indication for PDU set integrated packet handling is true, the associated PDU set integrated packet handling information further includes at least one of a discard indication for dependency, a discard timer, or a discard type.

16. The method of claim 12, wherein the transmitting comprises transmitting the constructed stream information including at least one of a Quality of Service Flow ID (QFI), a stream ID, a frame type, or an importance value, and the associated PDU set integrated packet handling information to the RAN node.

17. A method performed by a network node, comprising:
receiving, from a session management function (SMF), for a specific user equipment (UE) and Protocol Data Unit (PDU) session, stream information and an associated PDU set integrated packet handling information, wherein the stream information includes at least one stream indicator each indicating a stream associated with Extended Reality (XR) traffic, and the PDU set integrated packet handling information includes an indication for PDU set integrated packet handling associated with each stream indicator; and
handling each stream indicated by at least one stream indicator contained in the stream information according to the indication for PDU set integrated packet handling associated with the stream indicator indicating the stream.

18. The method of claim 17, wherein the network node is a user plane function (UPF) or a Radio Access Network (RAN) node.

19. The method of claim 17, further comprising providing a downstream node with discard PDU set information associated with a PDU set if the PDU set is not received completely.

20. The method of claim 17, wherein the stream information includes at least one of a 5G Quality of Service Identifier (5QI), a slice/service type (SST) or Single Network Slice Selection Assistance Information (S-NSSAI), a Data Network Name (DNN), an application identifier (appId), a QoS Flow ID (QFI), a stream ID, a frame type, an importance value, or a service data flow filter.
